(19) United States
(12) Patent Application Publication
(10) Pub. No.: US 2002/0044710 A1
(43) Pub. Date: Apr. 18, 2002

(54) Optical fiber non-reciprocal phase shifter

(76) Inventor: Henry Hung, Paradise Valley, AZ (US)

Correspondence Address: DONALD J. LENKSZUS, P.C., P.O. Box 3064, Carefree, AZ, 85377-3064, US

(21) Appl. No.: 09/811,840

(22) Filed: Mar. 19, 2001

Related U.S. Application Data
(60) Provisional application No. 60/240,623, filed on Oct. 16, 2000.

(51) Int. Cl. G02F 1/095

(52) U.S. Cl. 385/3; 359/281

(57) ABSTRACT

The invention is a non-reciprocal phase shifter that operates on optical signals. A Faraday rotator crystal is utilized in conjunction with a magnetic field source to produce non-reciprocal phase shifts in optical signals traversing the crystal in opposite directions.

### FIELD OF THE INVENTION

This invention pertains to optical phase shifters, in general, and to optical non-reciprocal phase shifters, in particular.

### BACKGROUND OF THE INVENTION

A non-reciprocal phase shifter introduces a predetermined phase shift into an optical signal propagating in one direction and a different predetermined phase shift into an optical signal propagating in the opposite direction. In some instances, the magnitude of the phase shift in both directions is the same, but the shifts are of opposite sign. Optical non-reciprocal phase shifters are useful in a variety of applications including telecommunications and optical gyroscopes. It is highly desirable to provide a non-reciprocal phase shifter that is easy to manufacture, small in size and inexpensive.

### SUMMARY OF THE INVENTION

In accordance with the principles of the invention, a non-reciprocal optical phase shifter, comprises a magneto-optic waveguide body of a material that, when subjected to magnetic fields, causes Faraday rotation effects on optical signals of a predetermined polarization. First and second waveguides are coupled to the magneto-optic waveguide body to couple optical signals thereto. A magnetic field source proximate the magneto-optic body, subjects the body to a magnetic field such that a non-reciprocal optical phase shift is produced in optical signals traversing said body in opposite directions.

A first graded index lens couples the first waveguide to the magneto-optic body and a second graded index lens couples the second waveguide to the body.

In the illustrative embodiment of the invention the magneto-optic body comprises a Faraday rotator crystal of yttrium iron garnet and the first and second waveguides are optical fibers.

In accordance with one aspect of the invention the magnetic field source is an electromagnet.

### BRIEF DESCRIPTION OF THE DRAWING

The invention will be better understood from a reading of the following detailed description in conjunction with the drawing figures in which like reference numerals are used to designate like elements, and in which:

FIG. 1 is a cross-section of a non-reciprocal phase shifter for single polarization in accordance with the invention; and

FIG. 2 is a cross-section of a second polarization independent, non-reciprocal phase shifter in accordance with the invention.

### DETAILED DESCRIPTION

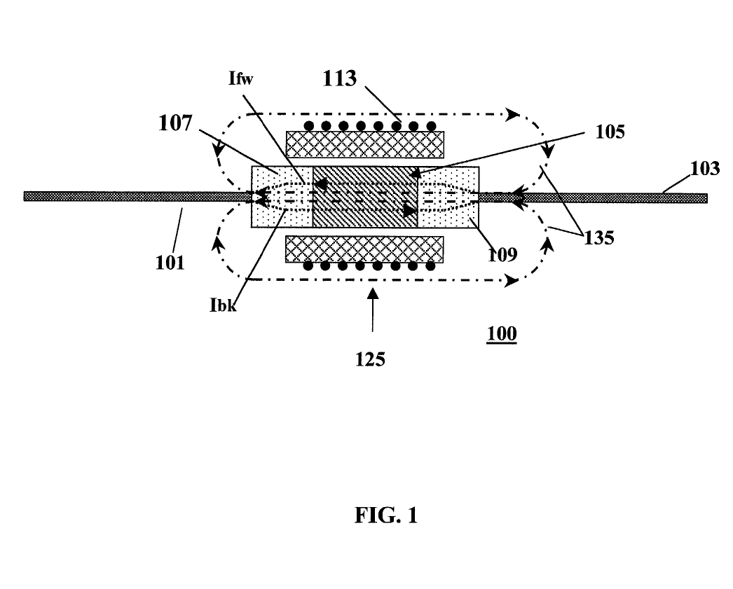

FIG. 1 illustrates a first embodiment of a non-reciprocal phase shifter 100 in accordance with the invention. Optical signals are coupled to and from the non-reciprocal phase shifter 100 via optical waveguides 101, 103, which in the particular embodiment shown are optical fiber. However, in other embodiments, one or both of the waveguides 101, 103 may be waveguides formed on a substrate and the non-reciprocal phase shifter may be formed on the substrate also as an integrated optic device. Non-reciprocal phase shifter 100 comprises a Faraday rotator crystal 105 which may be a crystal or thin-film device. A graded index lens 107 is attached to the end of optical fiber 101 and is attached to Faraday rotator crystal 105. A second graded index lens 109 is coupled to optical fiber 103 and to Faraday rotator crystal 105. Lenses 107, 109 are bonded to optical fibers 101, 103, respectively and to Faraday rotator crystal 105 with an epoxy cement. Graded index lenses 101, 103 are each of a type known in the trade as Sel-Foc lenses.

Faraday rotator crystal 105 may be any magneto-optic material that demonstrates Faraday rotation such as Yttrium Iron Garnet or Bismuth Iron Garnet.

An electromagnet 125 disposed proximate Faraday rotator crystal 105 includes a coil assembly 113. Electromagnet 125 provides a magnetic field indicated by field lines 135 when current flows through coil 113. Non-reciprocal phase shifter 100 operates with optical waves of a single polarization. The polarization, i.e., TE or TM, is determined by the selected crystal orientation. Optical signals in one direction through non-reciprocal phase shifter 100 are designated as forward beam signals Ifw, and optical signals in the opposite direction are designated as backward beam signals Ibk. For forward beam signals Ifw, non-reciprocal phase shifter 100 provides a phase shift of ωt+Φ. For backward beam signals Ibw, non-reciprocal phase shifter 100 provides a reciprocal phase shift of ωt−Φ.

The non-reciprocal phase shifter 100 of FIG. 1 is simply assembled, with construction similar to that of optical isolators. Advantageously, non-reciprocal phase shifter 100 provides low insertion loss of 1 dB or less, low cost and small size, i.e., under 1 inch in length.

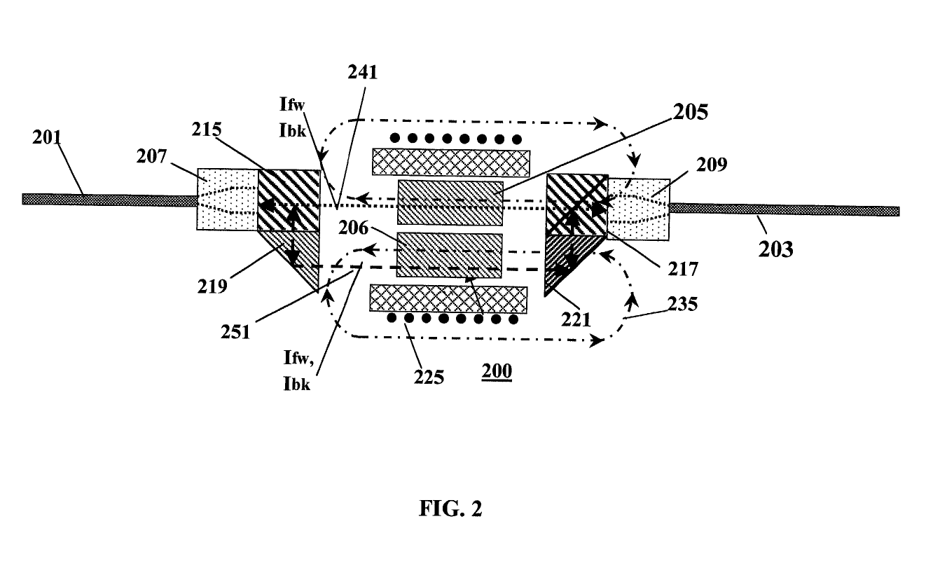

FIG. 2 illustrates a second non-reciprocal phase shifter 200 in accordance with the principles of the invention. Non-reciprocal phase shifter 200 differs in operation from non-reciprocal phase shifter 200 in that it is polarization independent. Non-reciprocal phase shifter 200 operates on TM and TE polarized signals, or signals with both TE and TM components. As with the structure of FIG. 1, optical signals are coupled to and from non-reciprocal phase shifter 200 via optical waveguides 201, 203. As with non-reciprocal phase shifter 100, waveguides 201, 203 are shown as optical fibers. However, one or both optical waveguides 201, 203 may be an optical waveguide carried on a substrate. Non-reciprocal phase shifter 200 may be formed on the same substrate with waveguides 201, 203 as an integrated optic device. Optical waveguides 201, 203 are coupled respectively to Sel-Foc lenses 207, 209. Two Faraday rotators crystals 205, 206 are utilized. One Faraday rotator crystal 205 is used for TE polarization optical signals and the other Faraday rotator crystal 206 is used for TM polarization optical signals. Each Faraday rotator crystal 205, 206 is oriented so that the magnetic field produced by electromagnet 225 produces a phase shift. Each Sel-Foc lens 207, 209 is coupled to a corresponding polarization beam splitter 215, 217. Beam splitters 215, 217 are in turn optically coupled to reflecting prisms 219, 221 to separate the TE and TM polarized optical signals. An electromagnet 225 disposed proximate Faraday rotator crystals 205, 206 includes a coil assembly 213. Electromagnet 225 provides a magnetic field indicated by field lines 235 when current flows through coil 213. With the arrangement shown in FIG. 2, two bi-directional optical paths can be traced through non-reciprocal phase shifter 200.

A first optical path for TE polarized wave components follows arrow 241. Starting at the left end of non-reciprocal phase shifter 200, TE polarized wave components on optical waveguide 203 are coupled to Sel-Foc lens 209. Sel-Foc lens 209 couples the TE polarized wave components to polarization beam splitter 217, which couples the TE polarized light to Faraday rotator crystal 205. From Faraday rotator crystal 205, the TE polarized wave components are coupled to polarization beam splitter 215, and then to Sel-Foc lens 207 and to waveguide 201.

For forward propagating TE polarized wave components, Ifw, non-reciprocal phase shifter 100 provides a phase shift of ωt+Φ. For backward propagating TE polarized beam signals Ibw, non-reciprocal phase shifter 100 provides a reciprocal phase shift of ωt−Φ.

A second optical path for TM polarized wave components follows arrow 251. Starting at the left end of non-reciprocal phase shifter 200, TM polarized light on optical waveguide 203 is coupled to Sel-Foc lense 209. Sel-Foc lens 209 couples the TM polarized light to polarization beam splitter 217, which couples the TM polarized light to reflecting prism 221. The TM signals are coupled to Faraday rotator crystal 206. From Faraday rotator crystal 206, the TM polarized light is coupled to reflecting prism 219. From reflecting prism 219, the TM polarized light is coupled to polarization beam splitter 215, and then to Sel-Foc lens 207 and to waveguide 201.

For forward propagating TM polarized wave components Ifw, non-reciprocal phase shifter 100 provides a phase shift of ωt+Φ. For backward propagating TM polarized beam signals Ibw, non-reciprocal phase shifter 100 provides a reciprocal phase shift of ωt−Φ. As with the non-reciprocal phase shifter of FIG. 1, non-reciprocal phase shifter 200 exhibits very low loss, 1 dB or less, is physically small and is of low cost.

As will be appreciated by those skilled in the art, various modifications can be made to the embodiments shown in the various drawing figures and described above without departing from the spirit or scope of the invention. In addition, reference is made to various directions in the above description. It will be understood that the directional orientations are with reference to the particular drawing layout and are not intended to be limiting or restrictive. It is not intended that the invention be limited to the illustrative embodiments shown and described. It is intended that the invention be limited in scope only by the claims appended hereto.

What is claimed is:

1. A non-reciprocal optical phase shifter, comprising:
a magneto-optic waveguide body of a material that, when subjected to magnetic fields, causes Faraday rotation effects on optical signals of a predetermined polarization;
a first waveguide coupled to said body;
a second waveguide coupled to said body;
a magnetic field source proximate said body, said magnetic field source subjecting said body to a magnetic field such that said body produces non-reciprocal optical phase shifts in optical signals traversing said body in opposite directions.

2. A non-reciprocal optical phase shifter in accordance with claim 1, comprising:
a first optical coupler said first waveguide to said body; and
a second optical coupler coupling said second waveguide to said body.

3. A non-reciprocal optical phase shifter in accordance with claim 1, wherein:
said body comprises a Faraday rotator crystal.

4. A non-reciprocal optical phase shifter in accordance with claim 3, wherein:
said Faraday rotator crystal comprises a crystal of yttrium iron garnet.

5. A non-reciprocal optical phase shifter in accordance with claim 4, wherein:
said magnetic field source comprises an electromagnet.

6. A non-reciprocal optical phase shifter in accordance with claim 1, wherein:
said body comprises Bismuth iron garnet.

7. A non-reciprocal phase shifter in accordance with claim 1, wherein:
said magnetic field source comprises an electromagnet.

8. A non-reciprocal phase shifter in accordance with claim 1, wherein:
said first waveguide comprises optical fiber; and
said second waveguide comprises optical fiber.

9. A non-reciprocal phase shifter in accordance with claim 1, wherein:
said first and second waveguides are integrated onto a substrate.

10. A non-reciprocal phase shifter in accordance with claim 1, wherein:
said magnetic field source produces a variable magnetic field.
